(19) United States
(12) Patent Application Publication
(10) Pub. No.: US 2019/0131057 A1
(43) Pub. Date: May 2, 2019

(54) COIL ASSEMBLY WITH MULTIPLE COIL WIRINGS

(71) Applicant: Samsung Electro-Mechanics Co., Ltd, Suwon-si (KR)

(72) Inventors: Geun Young PARK, Suwon-si (KR); Dae Ung AHN, Suwon-si (KR); Young Seung ROH, Suwon-si (KR); Dae Seong JEON, Suwon-si (KR); Sung Uk LEE, Suwon-si (KR); Jae Suk SUNG, Suwon-si (KR)

(73) Assignee: Samsung Electro-Mechanics Co., Ltd, Suwon-si (KR)

(21) Appl. No.: 16/030,012

(22) Filed: Jul. 9, 2018

(30) Foreign Application Priority Data
Oct. 30, 2017 (KR) 10-2017-0142701
Jan. 9, 2018 (KR) 10-2018-0002810

(51) Int. Cl. H01F 27/28; H01F 38/14; H01F 41/04; H01F 27/29; H04B 5/00

(52) U.S. Cl. CPC H01F 27/2823; H01F 38/14; H01F 27/2804; H02J 7/025; H01F 27/29; H04B 5/0075; H01F 41/041

(57) ABSTRACT

A coil assembly includes an insulating plate, a first wiring disposed on a first surface of the insulating plate and comprising a first spiral wiring, and a second wiring disposed on a second surface of the insulating plate, and electrically connected to the first wiring, wherein the second wiring includes a second spiral wiring that extends from the first spiral wiring, and the first wiring and the second wiring have different cross-sectional shapes.

### CROSS-REFERENCE TO RELATED APPLICATIONS

This application claims the benefit under 35 U.S.C. § 119(a) of Korean Patent Application Nos. 10-2017-0142701 filed on Oct. 30, 2017 and 10-2018-0002810 filed on Jan. 9, 2018 in the Korean Intellectual Property Office, the entire disclosures of which are incorporated herein by reference for all purposes.

### BACKGROUND

### 1. Field

The present disclosure relates to a coil assembly.

### 2. Description of Related Art

Portable terminals have been implemented with a system for wirelessly receiving power to charge a battery of the portable terminal, or to implement functions such as radio frequency identification (RFID), near-field communication (NFC), and magnetic secure transmission (MST), for example.

Such functions are generally performed through various coils, and as a result, portable terminals may be provided with a plurality of coils.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a coil assembly includes an insulating plate, a first wiring disposed on a first surface of the insulating plate and comprising a first spiral wiring, and a second wiring disposed on a second surface of the insulating plate, and electrically connected to the first wiring, wherein the second wiring includes a second spiral wiring that extends from the first spiral wiring, and the first wiring and the second wiring have different cross-sectional shapes.

The first wiring may be formed so that a width of a bonded surface of the first wiring that is bonded to the insulating plate is narrower than a width of an opposite surface of the bonded surface of the first wiring, and the second wiring may be formed so that a width of a bonded surface of the second wiring that is bonded to the insulating plate is greater than or equal to a width of an opposite surface of the bonded surface of the second wiring.

The first wiring may be bonded to the insulating plate through an adhesive layer, and the second wiring may be directly bonded to the insulating plate.

The coil assembly may include a connection conductor disposed to penetrate through the insulating plate, and the first wiring and the second wiring may be electrically connected to each other through the connection conductor.

The first wiring may include a leading part disposed to be spaced apart from the first spiral wiring, and the second wiring may include a connection wiring that extends in an outer diameter direction from the second spiral wiring, and the connection wiring may be connected to the leading part.

The first wiring may include an insertion groove formed in a position that faces the connection wiring, and at least a portion of the connection wiring may be disposed in the insertion groove.

The connection wiring may be branched into a plurality of paths.

The connection wiring may have a line width greater than the first wiring or the second spiral wiring.

The first wiring may include a connection part disposed to be spaced apart from the first spiral wiring, the second wiring may include an arc shaped wiring disposed to be spaced apart from the second spiral wiring, and the second spiral wiring and the arc shaped wiring may be electrically connected to each other through the connection part.

The second wiring may include a connection wiring that extends in an outer diameter direction from the second spiral wiring, connection parts that respectively extend from the first spiral wiring and the connection wiring, and connection pads included in end portions of the connection parts.

The coil assembly may include a protective member disposed to cover the second wiring, wherein the connection pads comprise a region in which the connection parts are exposed externally from the protective member through pad holes formed in the protective member.

The coil assembly may further include a metal layer stacked on the connection parts exposed through the pad holes of the protective member.

The second spiral wiring may be formed in an arc shape.

The second wiring may be formed of a metal thin film wiring printed with a conductive material on the insulating plate.

The coil assembly may include a first coil wiring configured by the first wiring and the second wiring, and a second coil wiring disposed to be stacked with the first coil wiring, and the first coil wiring and the second coil wiring may each perform any one function of transmission and reception of power for wireless charging, radio frequency identification (RFID), near filed communication (NFC), and magnetic secure transmission (MST).

The second coil wiring may be in a proximate location to the first coil wiring.

The second wiring may have a thickness equal to or less than the first wiring.

The second spiral wiring may have a line width equal to or less than the first spiral wiring.

In a general aspect, a coil assembly includes an insulating plate, and a coil wiring including a first wiring disposed on a first surface of the insulating plate and a second wiring disposed on a second surface of the insulating plate, wherein the first wiring includes an insertion groove formed in a position that faces the second wiring, and at least a portion of the second wiring is disposed in the insertion groove.

The coil wiring may include spiral wirings, and the spiral wirings may be disposed to be distributed in the first wiring and the second wiring.

A spiral wiring of the second wiring may have a line width narrower than a spiral wiring of the first wiring.

A spiral wiring of the second wiring may be disposed at a position that corresponds to a center region of the coil wiring that is formed by a spiral wiring of the first wiring.

In a general aspect, a coil assembly method includes bonding a first wiring to a first surface of an insulating plate using an adhesive substrate, printing a conductive material on a second surface of the insulating plate to form a second wiring, printing a connection conductor on the second surface of the insulating plate, and electrically connecting the first wiring to the second wiring through the connection conductor to form the coil assembly.

A first protective member may be attached to a surface of the first wiring and a second protective member may be attached to a surface of the second wiring.

The first wiring and the second wiring may have different cross-sectional shapes.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view schematically illustrating an example of electronic device;

FIG. 2 is a block diagram illustrating an example of a cross-sectional view of the electronic device of FIG. 1 taken along the line II-II′ of FIG. 1;

FIG. 3 is a plan view schematically illustrating an example of a coil assembly of an electronic device;

FIG. 4 is an exploded perspective view of an example of a coil assembly;

FIG. 5 is a cross-sectional view of the electronic device taken along line V-V′ of FIG. 3;

FIGS. 6A and 6B are cross-sectional views of the electronic device of FIG. 3 taken along line VI-VI′ of FIG. 3;

FIGS. 7 and 8 are views illustrating examples of a manufacturing method of a coil assembly

FIG. 9 is an exploded perspective view schematically illustrating an example of a coil assembly;

FIG. 10 is a plan view schematically illustrating an example of a coil assembly;

FIG. 11 is an exploded plan view illustrating an example of a coil assembly;

FIG. 12 is a plan view schematically illustrating an example of a coil assembly;

FIG. 13 is an exploded perspective view schematically illustrating an example of a coil assembly;

FIG. 14 is a plan view schematically illustrating an example of a coil assembly;

FIG. 15 is an exploded perspective view of an example of a coil assembly;

FIGS. 16A and 16B are views illustrating examples of a process of manufacturing a first wiring;

FIG. 17 is an exploded perspective view schematically illustrating an example of a coil assembly; and

FIG. 18 is a perspective view schematically illustrating an example of a coil assembly.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be construed as being limited by these terms. These terms are only used to distinguish one member, component, region, layer or section from another region, layer or section. Thus, a first member, component, region, layer or section discussed below could be termed a second member, component, region, layer or section without departing from the teachings of the embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” other elements would then be oriented “below,” or “lower” the other elements or features. Thus, the term “above” can encompass both upward and downward orientations, depending on a particular direction of the figures. The device may be otherwise oriented (rotated 90 degrees or at other orientations) and the spatially relative descriptors used herein may be interpreted accordingly.

The terminology used herein describes particular embodiments only, and the present disclosure is not limited thereby. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments of the present disclosure will be described with reference to schematic views illustrating embodiments of the present disclosure. In the drawings, for example, due to manufacturing techniques and/or tolerances, modifications of the shape shown may be estimated. Thus, embodiments of the present disclosure should not be construed as being limited to the particular shapes of regions shown herein, for example, to include a change in shape results in manufacturing. The following embodiments may also be constituted by one or a combination thereof.

The contents of the present disclosure described below may have a variety of configurations and propose only a required configuration herein, but are not limited thereto.

The features of the examples described herein may be combined in various ways as will be apparent after an understanding of the disclosure of this application. Further, although the examples described herein have a variety of configurations, other configurations are possible as will be apparent after an understanding of the disclosure of this application.

In describing the various examples, a wireless charging device may collectively refer to a power transmitter transmitting power and a power receiver receiving and storing the power therein, for example.

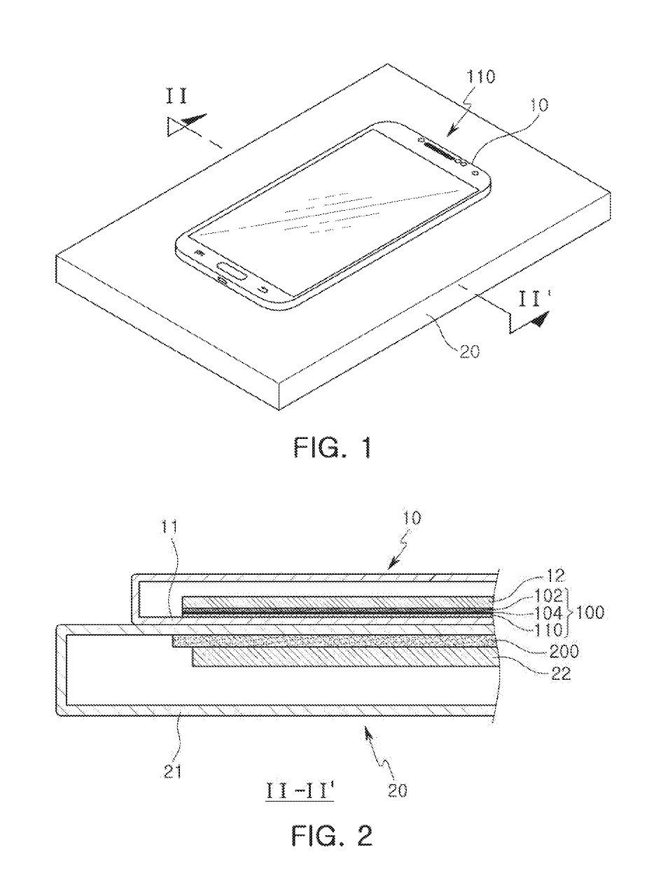

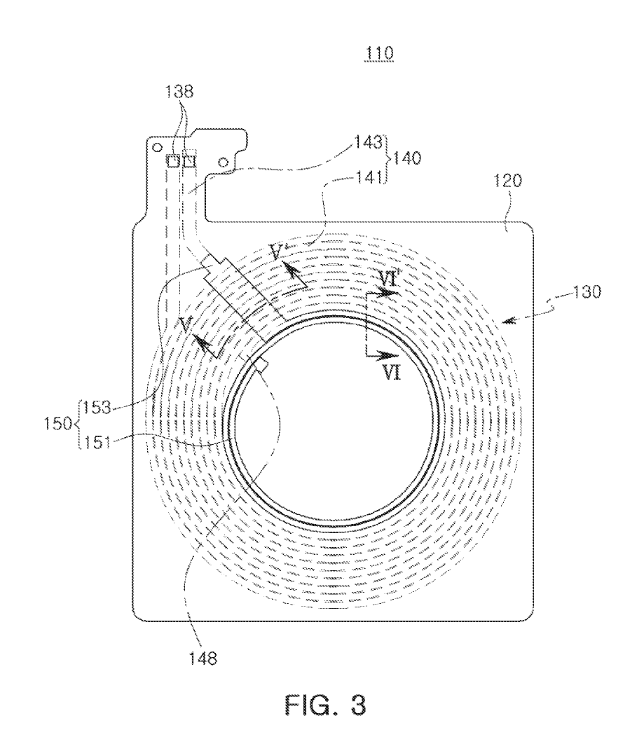

FIG. 1 is a perspective view schematically illustrating an example of an electronic device and FIG. 2 is a cross-sectional view of the electronic device taken along a line II-II′ of FIG. 1.

Referring to FIGS. 1 and 2, the electronic device, which may be a wireless charger, may be a charging device 20 that wirelessly transmits power, or a portable terminal 10 that wirelessly receives the power and stores the received power.

It is noted that use of the term “may” herein with respect to an example or embodiment, e.g., as to what an example or embodiment may include or implement, means that at least one example or embodiment exists where such a feature is included or implemented while all examples and embodiments are not limited thereto.

The portable terminal 10 may include a battery 12, and a power receiver 100 that receives the power and supplies the received power to the battery 12 and charges the battery 12 with the received power.

The battery 12 may be a chargeable and dischargeable secondary battery, and may be attached to and detached from the portable terminal 10, but is not limited thereto.

The power receiver 100 may be accommodated in a housing (or case) 11 of the portable terminal 10 and may be directly attached onto an inner surface of the housing 11 or may be disposed to be maximally adjacent thereto. However, the location of the battery is not limited thereto, and the battery may be located away from the surface of the housing 11.

The power receiver 100 may include a magnetic part 102 and a coil assembly 110.

The magnetic part 102 may have a flat plate shape (or a sheet shape), and may be disposed on one surface of the coil assembly 110 to be fixedly attached to the coil assembly 110. The magnetic part 102 may be provided to efficiently form a magnetic path of a magnetic field generated by a coil wiring of the coil assembly 110. To this end, the magnetic part 102 may be formed of a material that is able to easily form the magnetic path, and may be formed of, for example, a ferrite sheet.

In an example, a metal sheet included between the magnetic part 102 and the battery 12 to shield an electromagnetic wave or a leakage magnetic flux, as needed. The metal sheet may be formed of aluminum, but a material of the metal sheet is not limited thereto.

In an example, the power receiver 100 may include an adhesive portion 104 interposed between the coil assembly 110 and the magnetic part 102 so that the coil assembly 110 and the magnetic part 102 are firmly and fixedly adhered to each other.

The adhesive portion 104 may be disposed between the coil assembly 110 and the magnetic part 102, and may bond the magnetic part 102 and the coil assembly 110 to each other. Such an adhesive portion 104 may be formed of an adhesive sheet or an adhesive tape, and may also be formed by coating a surface of the coil assembly 110 or the magnetic part 102 with an adhesive or a resin having adhesive properties.

The adhesive portion 104 may contain ferrite powders, whereby the adhesive portion 104 may have magnetism together with the magnetic part 102.

The charging device 20 may be provided to charge the battery 12 of the portable terminal 10. To this end, the charging device 20 may include a voltage converter 22 and a power transmitter 200 in a housing 21.

The voltage converter 22 converts alternating current (AC) power supplied from an external source into direct current (DC) power, and reconverts the DC power into an AC voltage having a particular frequency to thereby provide the AC voltage to the power transmitter 200.

When the AC voltage is applied to the power transmitter 200, a magnetic field around the power transmitter 200 may be changed. Therefore, the power receiver 100 of the portable terminal 10, which may be disposed to be adjacent to the power transmitter, 200 may be applied with the voltage according to the change in the magnetic field, whereby the battery 12 may be charged.

The power transmitter 200 may be configured in a manner similar to that of the power receiver 100 described above. Therefore, a detailed description of the power transmitter 200 will be omitted.

Hereinafter, an example of the coil assembly 110 configuring the power receiver 100 will be described in detail.

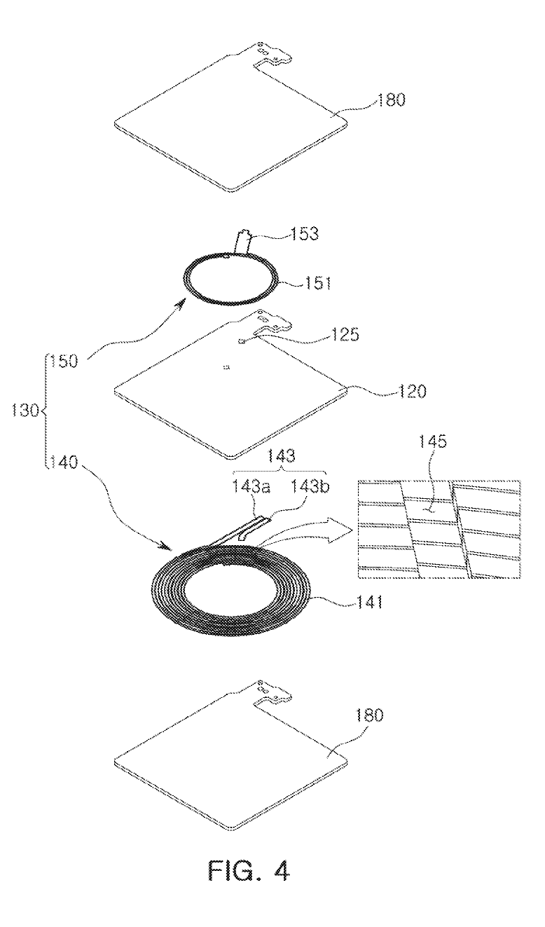

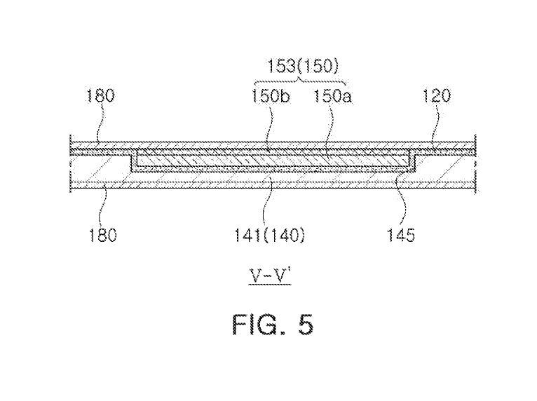

FIG. 3 is a plan view schematically illustrating an example of the coil assembly of FIG. 2 and FIG. 4 is an exploded perspective view of an example of the coil assembly illustrated in FIG. 3. Here, for convenience of explanation, FIG. 3 illustrates a state in which a protective member 180 of FIG. 4 is omitted.

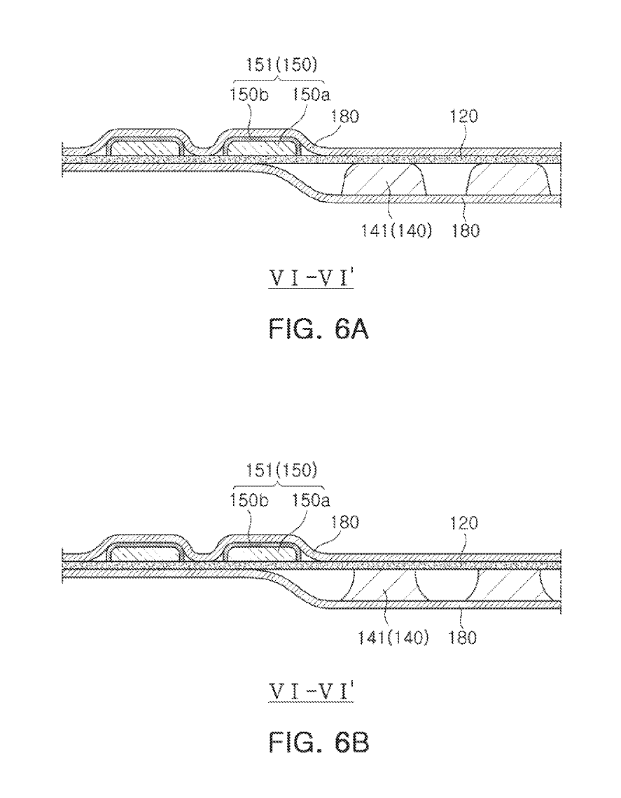

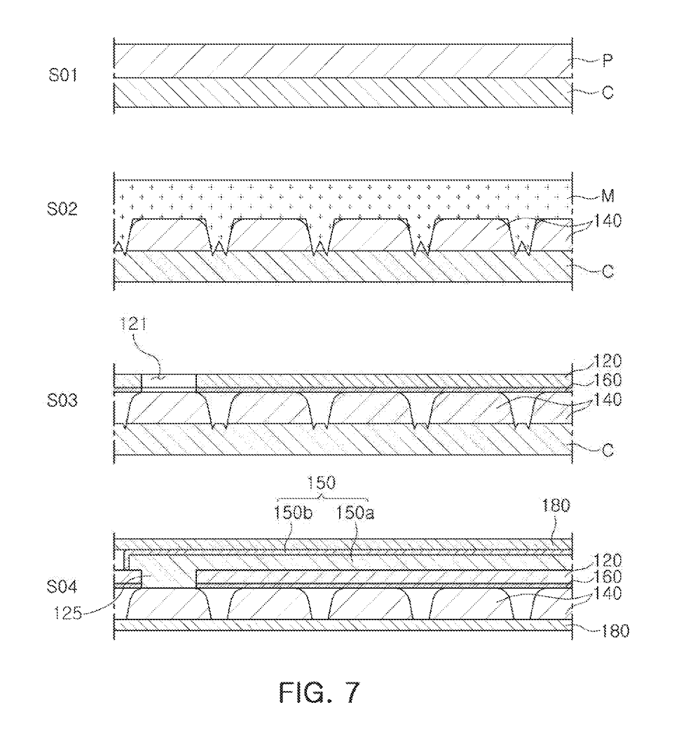

In addition, FIG. 5 is a cross-sectional view taken along the line V-V′ of FIG. 3 and FIG. 6 is a cross-sectional view taken along the line VI-VI′ of FIG. 3.

Referring to FIGS. 3 through 6, the coil assembly 110 according to respective examples, may include an insulating plate 120, and a coil wiring 130 formed through opposite surfaces of the insulating plate 120.

The insulating plate 120 may be an insulating substrate which forms a circuit wiring or a conductive pattern on the opposite surfaces thereof. As an example, an insulating film such as a polyimide film may form the material for the insulating plate 120. However, the material of the insulating plate 120 is not limited thereto, and the insulating plate 120 may be formed of various materials as long as a thickness of the insulating plate 120 is thin and metal thin films may be printed or attached on the opposite surfaces of the insulating plate 120.

The coil wiring 130 may include a first wiring 140 disposed on a first surface of the insulating plate 120, and a second wiring 150 disposed on a second surface of the insulating plate 120. Here, the first surface and the second surface of the insulating plate 120 refer to the opposite surfaces of the insulating plate 120 which are disposed in directions opposite to each other. The first wiring 140 and the second wiring 150 may be mounted in portable terminals that have a thin form factor. This coil structure may provide high power transmission efficiency, which may significantly reduce a size of the coil assembly, for example.

The first wiring 140 may include a first spiral wiring 141 formed in a spiral shape to have a plurality of turns, and a leading part 143. Here, the leading part 143 refers to a portion connecting both ends of the first spiral wiring 141 to connection pads 138.

The leading part 143 may be classified into a first leading part 143a and a second leading part 143b.

The first leading part 143a may extend from the first spiral wiring 141. In addition, the second leading part 143b may not be directly connected to the first spiral wiring 141 but may be disposed to be spaced apart from the first spiral wiring 141, and may be connected to the first spiral wiring 141 through the second wiring 150.

As a non-limiting example, as the first wiring 140, a press coil formed by press-processing a metal plate may be used. However, the configuration is not limited thereto, but various examples exist with various other configurations. For example, as the first wiring 140, a flat type coil (an edge wise coil) coated with an insulating coating may be used, or a general insulating wire may also be used.

The first wiring 140 may also be configured as a portion of a circuit wiring formed by etching the metal plate such as copper foil. In this example, the first wiring 140 may be manufactured by patterning copper clad laminates (CCL), but is not limited thereto.

Further, as illustrated in FIGS. 4 and 5, the first wiring 140 according to an example may include an insertion groove 145. A portion or an entirety of the insertion groove 145 to be described below may be inserted into and disposed in the insertion groove 145. Therefore, the insertion groove 145 may be formed in a region facing the connection wiring 153 and may be formed in a groove having a form in which a thickness of the first wiring 140 is reduced.

The insertion groove 145 may have a thickness the same as, or similar to, the thickness of the connection wiring 153. In addition, since the connection wiring 153 and the insulating plate 120 are inserted into and disposed in the insertion groove 145, a width of the insertion groove 145 may be greater than a width of the connection wiring 153.

Since the connection wiring 153 is disposed to be elongated in a direction crossing the first spiral wiring 141 of the first wiring 140, the insertion groove 145 may be formed in all turns constituting the first spiral wiring 141 of the first wiring 140.

Although not illustrated, in addition to the above-mentioned positions, the insertion groove 145 may be selectively formed in a region of the first wiring 140 facing the second wiring 150, depending on an example.

In an example in which the insertion groove 145 is not formed, a portion of the coil assembly in which the connection wiring 153 is disposed may protrude from the insulating plate 120. However, since the coil assembly in the example may include the insertion groove 145, the thickness of the coil assembly may be defined as a thickness of the first wiring 140, the insulating plate 120, and the protective member 180, when the connection wiring 153 is completely inserted into the insertion groove 145. In addition, although the connection wiring 153 partially protrudes externally from the insertion groove 145, since the thickness of the coil assembly is increased by the protruded thickness of the connection wiring 153, the thickness of the coil assembly may be significantly reduced.

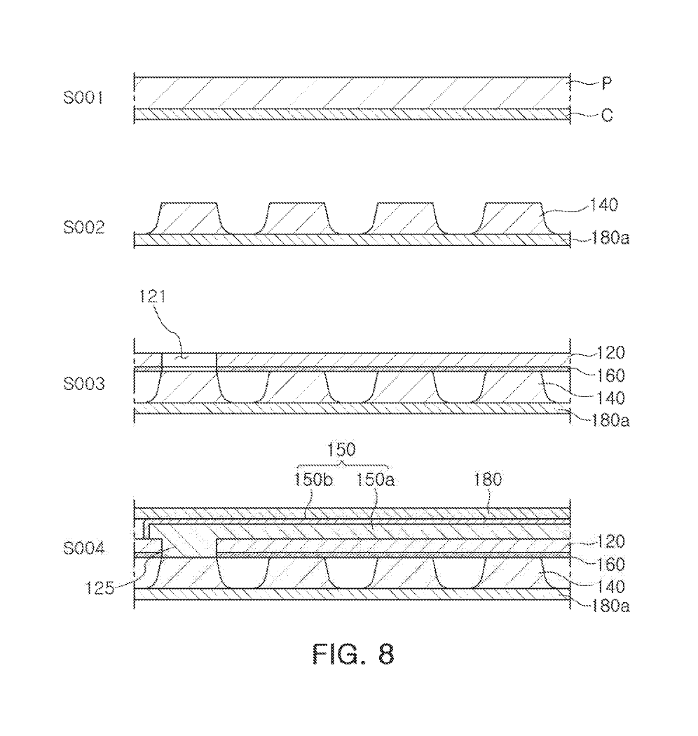

The first wiring 140 may be attached to the insulating plate 120 by an adhesive layer 160 (FIG. 7 or FIG. 8). As the adhesive layer 160, an adhesive tape may be used, but various types of adhesive members may be used as long as the first wiring 140 may be firmly bonded to the insulating plate 120 by a method such as forming the adhesive layer by applying a liquid adhesive, for example.

The second wiring 150 may be disposed on a second surface of the insulating plate 120 and may be connected to the first wiring 140. To this end, the connection conductor 125 (FIG. 4) that electrically connects the first wiring 140 and the second wiring 150 to each other may be disposed on the insulating plate 120. The connection conductor 125 may be formed by forming a through hole 121 (FIG. 7 or 8) in the insulating plate 120 and filling a conductive material in the through hole 121.

Hereinafter, in describing the examples, the connection between the first wiring 140 and the second wiring 150 means that the first wiring 140 and the second wiring 150 may be connected to each other by the connection conductor 125 included in the insulating plate 120 unless otherwise described.

The second wiring 150 may include a second spiral wiring 151 and a connection wiring 153.

The second spiral wiring 151 may be formed in a spiral shape, and may be disposed at a position corresponding to a center region of the first spiral wiring 141 of the first wiring 140. Here, the center region, which is a central portion of the first spiral wiring 141, refers to a region in which the wiring is not disposed. In addition, the position corresponding to the center region refers to a position facing an inner portion of the center region or a boundary of the center region of the first spiral wiring 141 with the insulating plate 120 interposed therebetween.

One end of the second spiral wiring 151 may be connected to the connection wiring 153 and the other end thereof may be connected to an end portion of the first spiral wiring 141 disposed at the center side of the first spiral wiring 141 through the connection conductor 125.

In addition, when the second spiral wiring 151 is projected onto the first surface of the insulating plate 120, the first spiral wiring 141 and the second spiral wiring 151 may be disposed so as not to overlap with each other except for a portion connected to the connection conductor 125.

In an example, the second spiral wiring 151 may have a plurality of turns. However, the second spiral wiring 151 is not limited thereto and may also be formed in one turn. Additionally, the second spiral wiring 151 may be formed in an arc shape, not a complete turn, as in an example to be described below.

A line width of the second spiral wiring 151 according to an example may be different from a line width of the first wiring 140. More specifically, in an example, the line width of the second spiral wiring 151 may be narrower than the line width of the first wiring 140.

Since a magnetic flux is concentrated on the center region of the coil wiring 130, an eddy current may be concentrated on a wiring (e.g., the second spiral wiring) close to the center region. In addition, the eddy current may be increased as a size (e.g., a width) of the wiring is larger.

However, in the example in which the line width of the second spiral wiring 151 is narrower than the line width of the first spiral wiring 141, since the width of the wiring is significantly reduced, an occurrence of the eddy current may be significantly suppressed and as a result, loss due to the eddy current may be significantly reduced.

In a non-limiting example, the second spiral wiring 151 may not be formed as the second wiring 150, but may be formed as a portion of the first wiring 140.

However, since the line width of the second spiral wiring 151 may be narrow, there may be a limitation in forming the second spiral wiring 151 by press processing together with the first wiring 140.

Therefore, in the coil assembly according to an example, the first wiring 140 may be manufactured with a line width that may be formed by the press processing, and a portion that is not easily manufactured by the press processing may be formed as the second wiring 150 by a printing method.

According to an example, a winding direction of the second spiral wiring 151 may be formed in the same direction as a winding direction of the first wiring 140. Additionally, an end portion of the second spiral wiring 151 that is disposed in the center of the second spiral wiring 151 may be connected to the first wiring 140, and an end portion of the second spiral wiring 151 disposed at the outer side of the spiral wiring 151 may be connected to the connection wiring 153.

To this end, an extension wiring 148 extended by a predetermined distance toward the center of the first spiral wiring 141 may be disposed at the end portion of the first spiral wiring 141 disposed at the center side so as to face the end portion of the second spiral wiring 151 disposed at the center side.

Such a configuration may be a configuration derived to form the second spiral wiring 151 in two or more turns, for example. Therefore, in an example in which the second spiral wiring 151 is formed in three or more turns, the extension wiring 148 may protrude to be a longer length.

The connection wiring 153 may be disposed in a form that crosses the first spiral wiring 141 of the first wiring 140 in a radial direction, one end of the connection wiring 153 may be connected to the second spiral wiring 151, and the other end of the connection wiring 153 may be connected to the second leading part 143b of the first wiring 140 through the connection conductor 125 from the outer side of the first spiral wiring 141.

Accordingly, the second leading part 143b of the first wiring 140 may be electrically connected to the first spiral wiring 141 through the second wiring 150.

Since the second wiring 150 may be formed by a method such as printing or plating, for example, as described below, the second wiring 150 may have a thickness thinner than the first wiring 140. Therefore, in an example in which the connection wiring 153 does not have a sufficient width, losses occurring in the connection wiring 153 may be increased.

To prevent these losses, according to an example, the connection wiring 153 may have a line width wider than the spiral second wiring 151 or the first wiring 140, and for example, the connection wiring 153 may have a width, equal to twice the width of the leading part 143. However, the connection wiring 153 is not limited thereto, and in an example in which the losses occurring in the connection wiring 153 are insignificant, the connection wiring 153 may have the same or similar width as the leading part 143 or the first wiring 140.

The second wiring 150 configured as described above may be formed by printing a conductive material on the insulating plate 120. The connection conductor 125 may be formed together with the second wiring 150 by filling the conductive material in the through hole formed in the insulating plate 120 in the process of forming the second wiring 150.

As the conductive material forming the second wiring 150, a material in which a resin and a conductive filler are mixed may be used, and for example, a conductive epoxy may be used. In this example, the second wiring 150 may be formed of a plurality of conductive fillers and a resin fixing the plurality of conductive fillers. However, the examples are not limited thereto.

Accordingly, the second wiring 150 may be formed as a metal thin film wiring to have a thickness thinner than the first wiring 140 formed as the press coil or the flat type coil.

The second wiring 150 may include at least one plated layer 150b (FIG. 5). In this example, the second wiring 150 may be classified as a conductive layer 150a (FIG. 5) that may be formed by printing a conductive material, or a plated layer 150b formed on a surface of the conductive layer 150a. In this example, the conductive layer 150a may be formed of a copper (Cu) material, and the plated layer 150b may be formed of a gold (Au) or nickel (Ni) material. However, the composition of the conductive layer 150a and the plated layer 150b is not so limited. In addition, the plated layer 150b may be formed in a plurality of layers, in examples.

Since the second wiring 150 may be formed by a printing and plating process, the second wiring 150 may have a thickness that is thinner than the first wiring 140. However, the second wiring 150 may also be formed to have the same thickness or the same line width as the first wiring 140 by stacking a plurality of plated layers, as needed.

As described above, in an example, the first wiring 140 and the second wiring 150 may be manufactured by different methods. Therefore, the first wiring 140 and the second wiring 150 may have different cross-sectional shapes.

In an example in which the first wiring 140 is formed as the press coil, a cross section of the first wiring 140 may be formed so that a width of a bonded surface of the first wiring 140 that is bonded to the insulating plate 120 is narrower than a width of an opposite surface of the bonded surface, that is, a surface of the first wiring 140 that is attached to the protective member 180, as illustrated in FIG. 6A. A shape of the press coil will be described in more detail in a manufacturing method to be described below.

Similarly, in an example in which the first wiring 140 is formed by etching the metal plate (e.g., copper foil), both side surfaces of the cross section of the first wiring 140 may be formed to be concave, and the width of the bonded surface of the first wiring 140 that is bonded to the insulating plate 120 may be narrower than the width of the opposite surface of the bonded surface, that is, a surface of the first wiring 140 that is attached to the protective member 180, as illustrated in FIG. 6B. Such a shape may be naturally formed in a process of removing unnecessary portions of the metal plate by the etching method. This will also be described in more detail in the manufacturing method to be described below.

Since the second wiring 150 may be formed by the printing method, a width of a bonded surface of the second wiring 150 that is bonded to the insulating plate 120 may be the same as, or greater than, a width of an opposite surface of the bonded surface.

Therefore, in an example, the cross section of the first wiring 140 may be formed so that the width of the bonded surface bonded to the insulating plate 120 is narrower than the width of the opposite surface, and the cross section of the second wiring 150 may be formed so that the width of the bonded surface is the same as, or greater than, the width of the opposite surface.

The coil assembly according to an example may include connection pads 138 (FIG. 3).

The connection pads 138 may each be disposed at end portions of the leading part 143. The connection pads 138 may be in contact with an external component and may be electrically connected to the external component. In an example, the connection pads 138 may be disposed on the first surface of the insulating plate 120 in a square patch shape. However, the connection pads 138 are not limited thereto, but may be formed on the second surface of the insulating plate 120 or may also be formed in various shapes such as a circular shape or a polygonal shape, for example.

In addition, in an example, the coil assembly may include a protective member 180. The protective member 180 may cover the first wiring 140 and the second wiring 150 and may be coupled onto the opposite surfaces of the insulating plate 120, e.g., to protect the coil wiring 130 from external environmental elements.

As the protective member 180, various members, such as an insulating film or an insulating tape, may be used as long as they may be easily coupled to the insulating plate 120 and have electrical insulation.

Since the connection pads 138 may be regions which are in contact with the external component, the protective member 180 may be partially removed from the connection pads 138, and as a result, at least a portion of the connection pads 138 may be exposed externally from the protective member 180.

Since the example coil assembly described above may have the second wiring 150 disposed in the insertion groove 145 formed in the first wiring 140, the thickness of the coil assembly may be significantly reduced, and as a result, the coil assembly may be easily mounted in the thin portable terminal.

Additionally, in the coil wiring 130 of the coil assembly, the spiral wirings 141 and 151 may be respectively disposed to be distributed in the first wiring 140 and the second wiring 150 which are disposed on the opposite surfaces of the insulating plate 120. Therefore, inductance of the entire spiral wiring may be adjusted by adjusting a length of the second wiring 150 in a process of collectively manufacturing the first wiring 140 through the press processing and printing the second wiring 150. Therefore, the inductance may be tuned during the manufacturing process.

Next, a manufacturing method of the coil assembly illustrated in FIG. 3 will be further described with reference to FIGS. 7 and 8. FIG. 7 illustrates an example of a manufacturing method using the press coil as the first wiring 140, and FIG. 8 is a cross-sectional view illustrating an example of a manufacturing method etching the metal plate and using the etched metal plate as the first wiring 140. In FIGS. 7 and 8, the second wiring 150 represents the connection wiring 153.

Referring to FIG. 7, in an example, the manufacturing method of the coil assembly may first include an operation of preparing a first wiring 140.

The first wiring 140 may be prepared by preparing a metal plate P in which a carrier film C is attached to a second surface of the metal plate P (operation S01), and then pressing the metal plate P with a press mold M (operation S02). In this example, due to a structure of a press mold M, a cross section of the first wiring 140 may be formed so that a second surface of the first wiring 140 has a width greater than a first surface of the first wiring 140.

If the first wiring 140 is prepared, the first surface of the first wiring 140 may be bonded to a first surface of an insulating plate 120 (operation S03). In this example, an adhesive layer 160 may be interposed between the first surface (the bonded surface) of the first wiring 140 and the insulating plate 120.

In addition, a connection conductor 125 and a conductive layer 150a may be formed by printing a conductive material on the second surface of the insulating plate 120 and in a through hole 121, and a plated layer 150b may be formed by performing a plating process. As a result, the second wiring 150 may be completed.

Next, the coil assembly may be completed (operation S04) by removing the carrier film C attached onto the second surface of the first wiring 140 and then attaching a protective member 180 on a surface of the second wiring 150 and the first surface of the first wiring 140, respectively.

In an example in which the metal plate P is etched to be used as the first wiring 140, as illustrated in FIG. 8, the metal plate P in which an insulating film 180a is attached onto a second surface may be prepared (operation S001), and the first wiring 140 may then be prepared by removing unnecessary portions of the metal plate P through an etching process (operation S002).

In this example, since the etching is more actively performed on the first surface of the metal plate P, easily brought into contact with an etchant than on the second surface of the metal plate P onto which the insulating film 180a is attached, the cross section of the first wiring 140 may be formed so that the second surface has a width greater than the first surface.

If the first wiring 140 is prepared, the first surface of the first wiring 140 may be bonded to the first surface of the insulating plate 120 (operation S003). In this example, an adhesive layer 160 may be interposed between the first surface of the first wiring 140 and the insulating plate 120.

Next, a connection conductor 125 and a conductive layer 150a may be formed by printing a conductive material on the second surface of the insulating plate 120 and in a through hole 121, and a plated layer 150b may be formed by performing a plating process. As a result, the second wiring 150 may be completed.

Next, the coil assembly may be completed by attaching the protective member 180a to a surface of the second wiring 150 (operation S004).

In an example illustrated in FIG. 8, the insulating film 180 may be used as the protective member 180 (FIG. 4) that protects the first wiring 140 without performing a separate processing. Therefore, as in the example of FIG. 7, a process of removing the carrier film C from the first wiring 140 and again attaching the protective member 180 may be omitted.

In the example of the manufacturing method of the coil assembly described above, the second wiring 150 and the connection conductor 125 may be formed and manufactured by coupling the first wiring 140 prepared by the press processing or the etching process onto the first surface of the insulating plate 120, and printing the conductive material on the second surface of the insulating plate 120 and in the through hole. Therefore, the coil assembly may be very easily manufactured, and manufacturing costs thereof may be greatly reduced as compared to the typical coil assembly using FPCB.

In addition, in the examples of the manufacturing method, the manufacturing methods of the first wiring 140 and the second wiring 150 may be different from each other, and as a result, the first wiring 140 and the second wiring 150 may have different cross-sectional shapes.

Specifically, the cross section of the first wiring 140 may be formed so that the width of the bonded surface, that is, the surface of the first wiring 140 that is bonded to the insulating plate 120, is narrower than the width of the opposite surface of the first wiring 140, and the cross section of the second wiring 150 may be formed so that the width of the bonded surface of the second wiring 150 is the same as or greater than the width of the opposite surface.

In addition, since the first wiring 140 may be attached to the insulating plate 120 by preparing the metal plate P and then processing it, the adhesive layer 160 may be essentially interposed between the first wiring 140 and the insulating plate 120.

On the other hand, since the second wiring 150 may be formed by directly printing the conductive material on the insulating plate 120, the adhesive layer 160 is not interposed between the second wiring 150 and the insulating plate 120, and the second wiring 150 may be directly bonded onto the insulating plate 120.

Therefore, the bonded structure of the first wiring 140 may be different from the bonded structure of the second wiring 150.

The examples are not limited to those described above, and may be variously deformed.

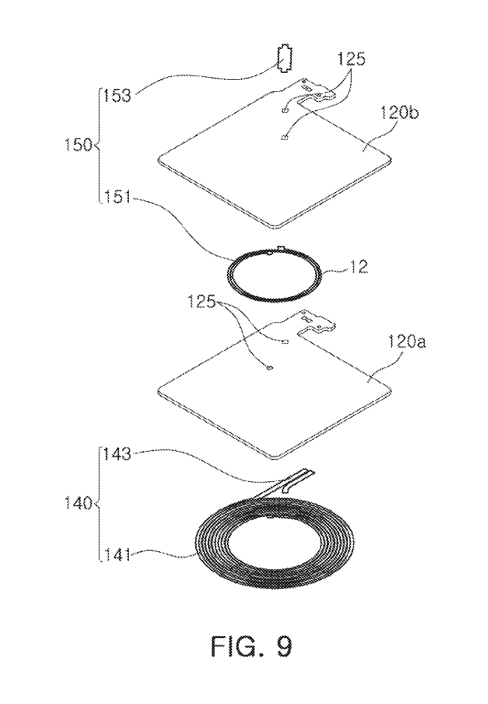

FIG. 9 is an exploded perspective view schematically illustrating an example of a coil assembly, such as the coil assembly of FIG. 4, although examples are not limited thereto. In the examples described below, the protective member 180 (e.g., FIG. 4) is omitted for convenience of explanation, but may be included or not included in different examples.

Referring to FIG. 9, in an example, the coil assembly may include a first insulating plate 120a and a second insulating plate 120b.

The first insulating plate 120a may be configured in a similar manner to the insulating plate 120 of the example described above with respect to any of FIGS. 3-8, for example. The first wiring 140 may be disposed on a first surface of the first insulating plate 120a, and the second spiral wiring 151 of the second wiring 150 may be disposed on a second surface of the first insulating plate 120a.

The second insulating plate 120b may be disposed to be stacked on the first insulating plate 120a. In addition, the second spiral wiring 151 of the second wiring 150 may be disposed on a first surface of the second insulating plate 120b, and as a result, the second spiral wiring 151 of the second wiring 150 may be disposed between the first insulating plate 120a and the second insulating plate 120b.

The connection wiring 153 of the second wiring 150 may be disposed on a second surface of the second insulating plate 120b. Therefore, in order to electrically connect the connection wiring 153 and the second spiral wiring 151 to each other, the second insulating plate 120b may include the connection conductor 125.

In an example, the coil assembly may be manufactured by coupling the first wiring 140 prepared through the press processing to the first surface of the first insulating plate 120a, forming the second spiral wiring 151 by printing the conductive material on the second surface of the first insulating plate 120a, stacking the second insulating plate 120b on the second spiral wiring 151, and then printing the connection wiring 153 on the second insulating plate 120b.

As described above, in a non-limiting example, the second wiring 150 may be disposed to be distributed between a plurality of insulating plates 120a and 120b. The second spiral wiring 151 and the connection wiring 153 may be formed by printing the conductive material on the first insulating plate 120a and the second insulating plate 120b.

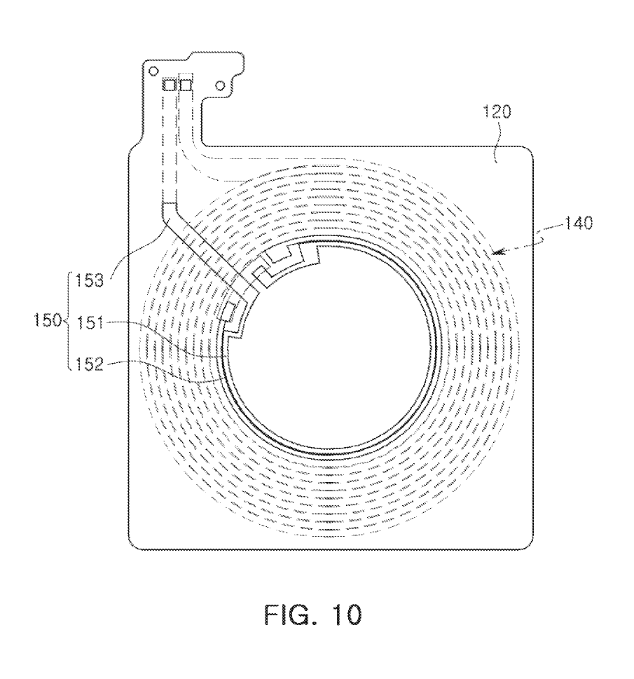

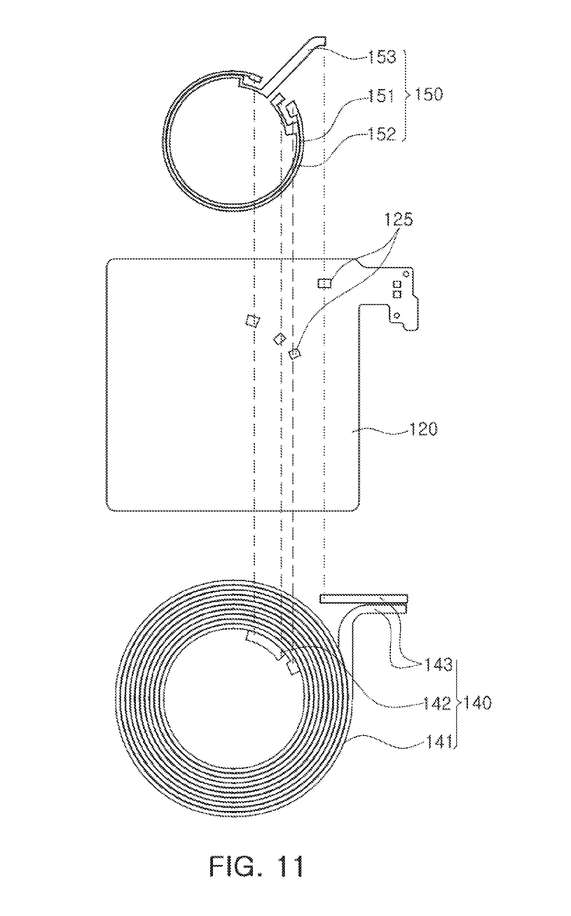

FIG. 10 is a plan view schematically illustrating an example of a coil assembly and FIG. 11 is an exploded plan view illustrating the coil assembly illustrated in FIG. 10, such as the coil assembly of FIG. 4, although examples are not limited thereto.

Referring to FIGS. 10 and 11, in the example coil assembly, the first wiring 140 may further include a connection part 142 in addition to the first spiral wiring 141 and the leading part 143. In addition, the second spiral wiring 151 of the second wiring 150 may include an arc shaped wiring 152, which may not be directly connected to the connection wiring 153, for example.

The arch shaped wiring 152 may be configured as a portion of the second spiral wiring 151, but may also be disposed to be spaced apart externally from the second spiral wiring 151 in a form surrounding the second spiral wiring 151 and may be electrically connected to the second spiral wiring 151 through the connection part 142 included in the first wiring 140.

Such a configuration may be a configuration derived to form the second spiral wiring 151 in two turns. Therefore, in an example in which the second spiral wiring 151 is formed in three or more turns, the arc shaped wiring 152 or the connection part 142 may be included.

In an example, the connection wiring 153 of the second wiring 150 may have the same width as the leading part 143 of the second wiring 150. As such, the width of the connection wiring 153 may be deformed in various form examples.

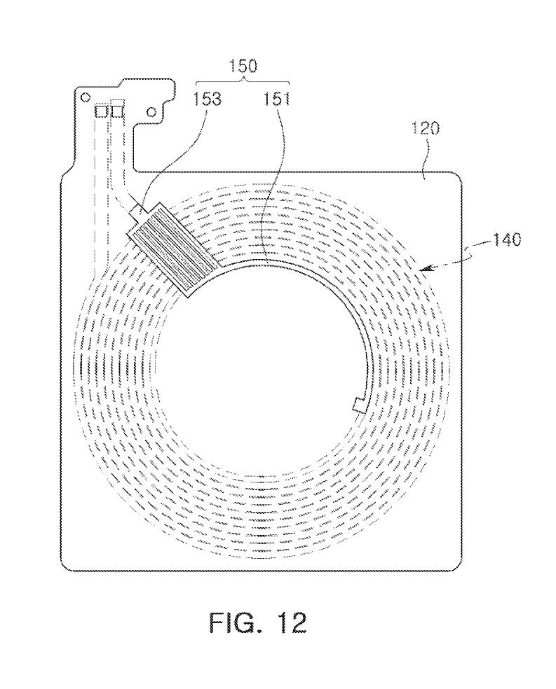

FIG. 12 is a plan view schematically illustrating an example of a coil assembly, such as the coil assembly of FIG. 4, although examples are not limited thereto.

Referring to FIG. 12, in the example coil assembly, the second spiral wiring 151 of the second wiring 150 may not form a complete one turn, but may be formed in an arc shape. As such, the second spiral wiring 151 may be deformed in various shapes as long as it may serve as a portion of the spiral coil together with the first spiral wiring 141.

In addition, the connection wiring 153 of the second wiring 150 is also representative of being branched to have a plurality of paths to have Litz wire properties. In this example, since the connection wiring 153 may have a form of Litz wire, it may provide an effect similar to the Litz wire.

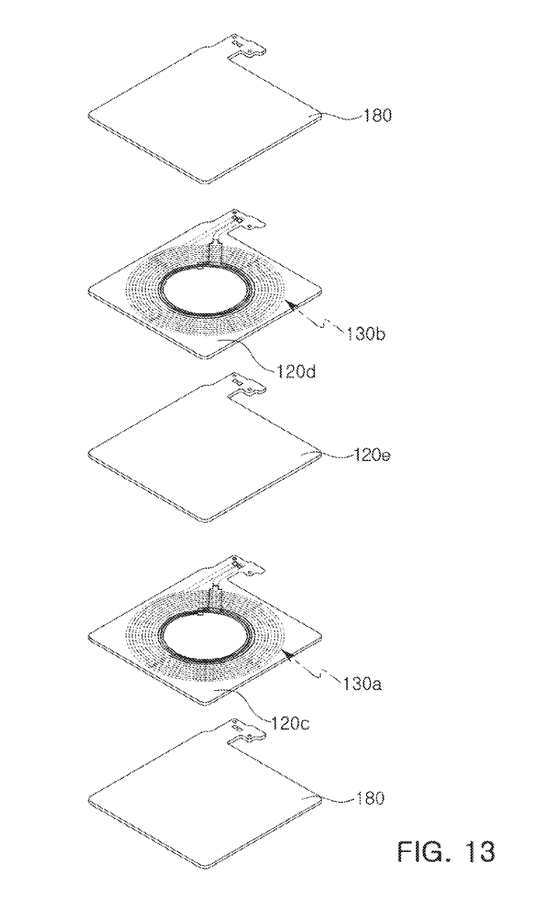

FIG. 13 is an exploded perspective view schematically illustrating an example of a coil assembly.

Referring to FIG. 13, example the coil assembly may include a plurality of coil wirings 130a and 130b.

In an example, the coil assembly may include first coil wirings 130a disposed on opposite surfaces of a third insulating plate 120c, and second coil wirings 130b disposed on opposite surfaces of a fourth insulating plate 120d. In addition, a separate insulating member 120e may be disposed between the first coil wiring 130a and the second coil wiring 130b.

The first coil wiring 130a and the second coil wiring 130b may each be configured in the same structure as the coil wiring 130 of FIG. 4 described above, and may be disposed to be stacked. Here, the same structure basically refers to a structure in which the first wiring and the second wiring are disposed to be distributed on the opposite surfaces of the insulating plate, and the first wiring and the second wiring together form the spiral coil.

However, the first coil wiring 130a and the second coil wiring 130b are not limited thereto, and the first coil wiring 130a and the second coil wiring 130b may also be formed to have a structure of a coil wiring according to the example illustrated in FIG. 10 or FIG. 12, and the first coil wiring 130a and the second coil wiring 130b may also be formed in different structures, in other examples.

In addition, the first coil wiring 130a and the second coil wiring 130b may be horizontally disposed on one insulating plate, or the first coil wiring 130a may be disposed on the center region of the second coil wiring 130b. As such, the second coil wiring 130b may be disposed in various positions, as long as the positions are around, or in close proximity to, the first coil wiring 130a.

The first coil wiring 130a and the second coil wiring 130b may each perform at least one function of transmission and reception of power for wireless charging, radio frequency identification (RFID), near-field communication (NFC), and magnetic secure transmission (MST), as non-limiting examples.

In a non-limiting example, the first coil wiring 130a may be used for transmission and reception of power for wireless charging, and the second coil wiring 130b may be used for any one of such example RFID, NFC, and MST.

In addition, various deformations are possible. For example, the first coil wiring 130a may be used for NFC and the second coil wiring 130b may be used for MST.

Although the example illustrates the coil assembly including the two coil wirings 130a and 130b, a third coil wiring and a fourth coil wiring may also be additionally disposed in the same way, in examples.

In addition, although an example in which the two coil wirings 130a and 130b have the same size is illustrated, the coil wirings may also have different sizes. For example, the second coil wiring 130b may be disposed in the center region of the first coil wiring 130a.

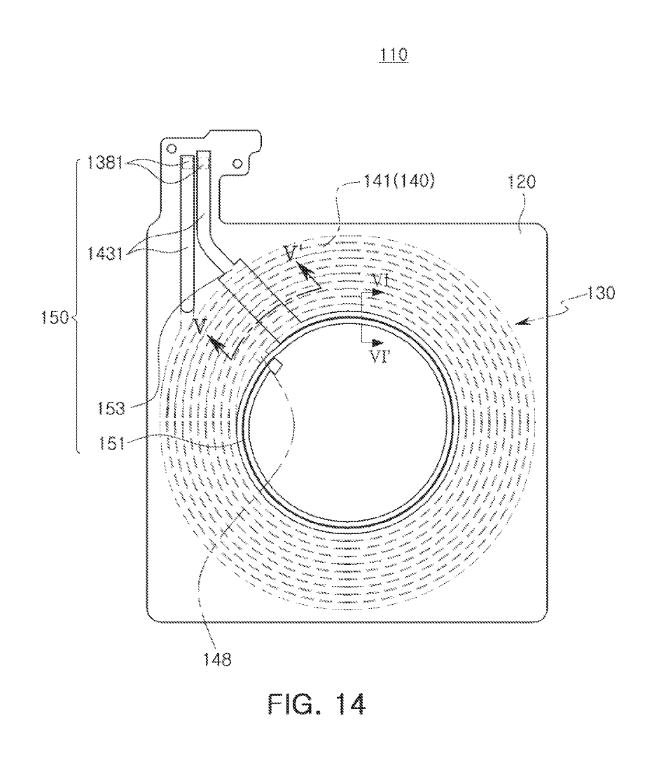

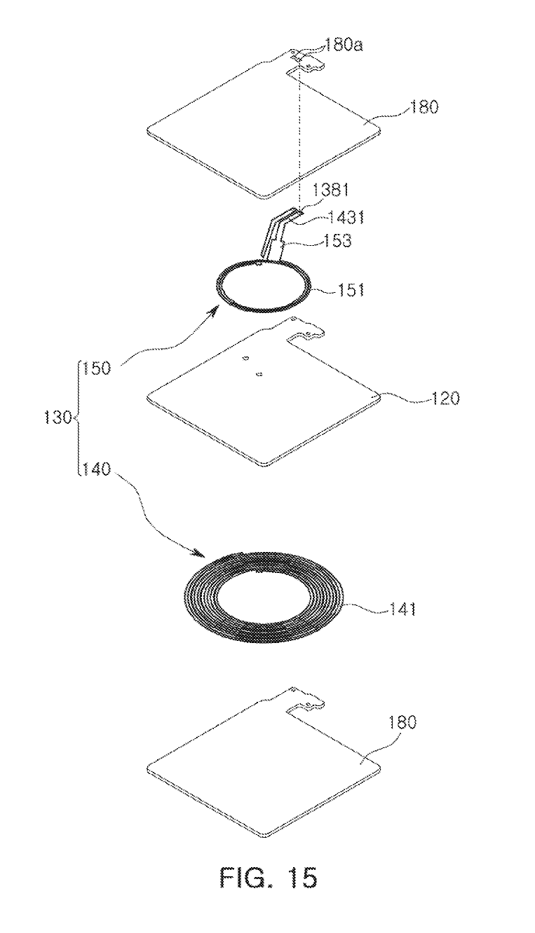

FIG. 14 is a plan view schematically illustrating an example of a coil assembly and FIG. 15 is an exploded perspective view of the example coil assembly illustrated in FIG. 14. For convenience of explanation, FIG. 14 illustrates a state in which the protective member 180 of FIG. 15 is not included.

In the example, the coil assembly may be configured in a manner similar to that of the coil assembly illustrated in FIGS. 3 and 4. These examples are not limited thereto. Therefore, a repeated detailed description of such components will be omitted.

Referring to FIGS. 14 and 15, the coil assembly may have a connection pad 1381 and a leading part 1431 which may be included in the second wiring 150. Therefore, the first wiring 140 may include only the first spiral wiring 141, and the second wiring 150 may include the second spiral wiring 151, the connection wiring 153, the leading part 1431, and the connection pad 1381.

According to the example, the leading part 1431 refers to a wiring that respectively connects the first spiral wiring 141 and the connection wiring 153 to the connection pad 1381.

The leading part 1431 and the connection pad 1381 may be formed by printing the conductive material on the insulating plate 120 in a manner that is similar to the second spiral wiring 151 or the connection wiring 153.

Therefore, the leading part 1431 and the connection pad 1381 may be formed together with the second spiral wiring 151 or the connection wiring 153 in the process (e.g., operation S03 in FIG. 7) of bonding the first surface of the first wiring 140 to the first surface of the insulating plate 120 and the process (e.g., operation S04 in FIG. 7) of forming the connection conductor 125 and the conductive layer 150a by printing the conductive material on the second surface of the insulating plate 120 and in the through hole 121, and forming the plated layer 150b by performing the plating process.

In addition, according to the example, the connection pad 1381 may be defined as a region exposed to the outside of the protective member 180 through a pad hole 180a formed in the protective member 180 among an end portion of the leading part 1431. Therefore, the connection pad 1381 may be configured as a portion of the leading part 1431.

However, the connection pad 1381 is not limited thereto. A metal layer may be additionally stacked on the end portion of the leading part 1431, and a portion on which the metal layer is formed may also be used as the connection pad 1381. Such a configuration may be implemented by attaching the protective member 180 onto the second surface of the insulating plate 120 in which the leading part 1431 is formed, and then applying or filling the conductive material in the pad hole 180a formed in the protective member 180.

The metal layer may be formed as a single layer or a plurality of layers, and may be selectively formed of materials such as copper (Cu) or gold (Au), nickel (Ni), for example. However, the configuration of the present disclosure is not limited thereto. The coil assembly according to the example may be manufactured by an operation of coupling the first wiring 140 prepared by a press processing or a photolithography method onto the first surface of the insulating plate 120, an operation of forming the connection conductor 125, the second spiral wiring 151, the connection wiring 153, the leading part 1431, and the connection pad 1381 by printing the conductive material on the second surface of the insulating plate 120, and an operation of attaching the protective member 180 onto the second surface of the insulating plate 120 so as to expose the connection pad 1381.

In the coil assembly configured as described above, the first wiring 140 may include only the first spiral wiring 141, and the remaining wiring (e.g., the second wiring) may be formed by printing the conductive material on the insulating plate 120. Therefore, the first wiring 140 may only be simply formed in the spiral shape. This will be described in more detail as follows.

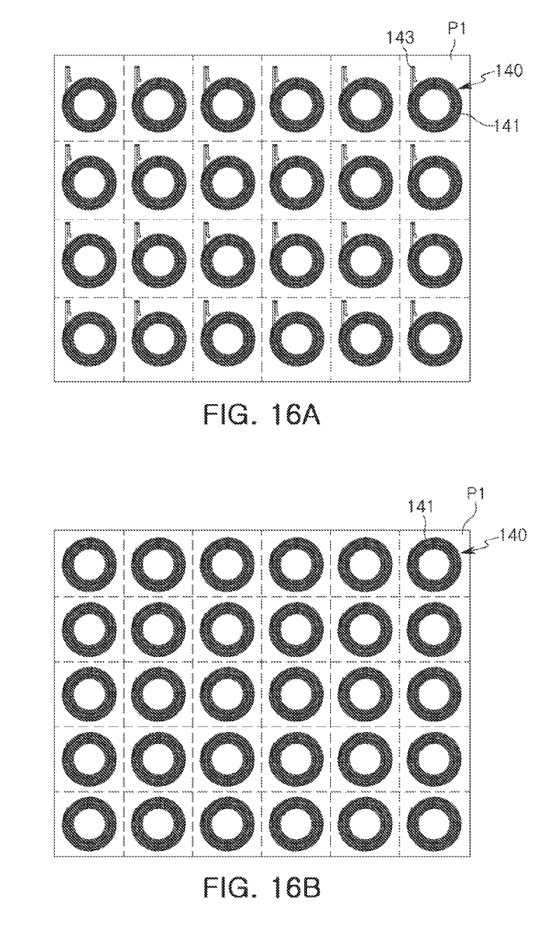

FIG. 16 is a view illustrating an example of a process of manufacturing the first wiring, and illustrates an example of a process of collectively manufacturing a plurality of first wirings 140, such as the coil assembly of FIG. 4, although examples are not limited thereto. For example, FIG. 16A illustrates an example of a process of manufacturing the first wiring 140 illustrated in FIG. 4 described above, and FIG. 16B illustrates an example of a process of manufacturing the first wiring 140 such as illustrated in FIG. 15.

In an example, the first wiring 140 may be formed by patterning copper clad laminates (CCL) or formed by press processing the metal plate as described above. Therefore, in FIGS. 16A and 16B, P1 may be the copper clad laminates or the metal plate. In addition, in FIGS. 16A and 16B, the first wiring 140 may be a metal pattern left on the copper clad laminates, or may be a press coil pressed from the metal plate.

Referring to FIGS. 16A and 16B, the first wiring 140 illustrated in FIG. 16A may include the first spiral wiring 141 and the leading part 143. In addition, the first wiring 140 illustrated in FIG. 16B may include only the first spiral wiring 141.

Therefore, an entire area occupied by one of the first wirings 140 illustrated in FIG. 16A may be greater than an area occupied by one of the first wirings 140 illustrated in FIG. 16B. Thereby, in an example in which the plurality of first wirings 140 are manufactured in a material P1 (the copper clad laminates or the metal plate) having the same size as illustrated in FIGS. 16A and 16B, since the first wirings 140 illustrated in FIG. 16B requires less manufacturing processes, the manufacturing time and cost may be reduced.

In addition, since the first wiring 140 illustrated in FIG. 16B includes only the first spiral wiring 141, various types of coil assemblies may be manufactured by manufacturing the plurality of first wirings 140 in the same shape (e.g., standard specification) and then adding the second wirings 150 in various shapes. Therefore, the coil assemblies having different positions and shapes of the leading part may be manufactured by configuring only the second wiring 150 differently with the same first wiring 140 without having to newly manufacture the entire coil assembly.

As described above, in an example, the size of the first wiring 140 may be significantly reduced and the first wiring 140 may be standardized. Therefore, the process of manufacturing the coil assembly may be simplified and the manufacturing cost thereof may be reduced.

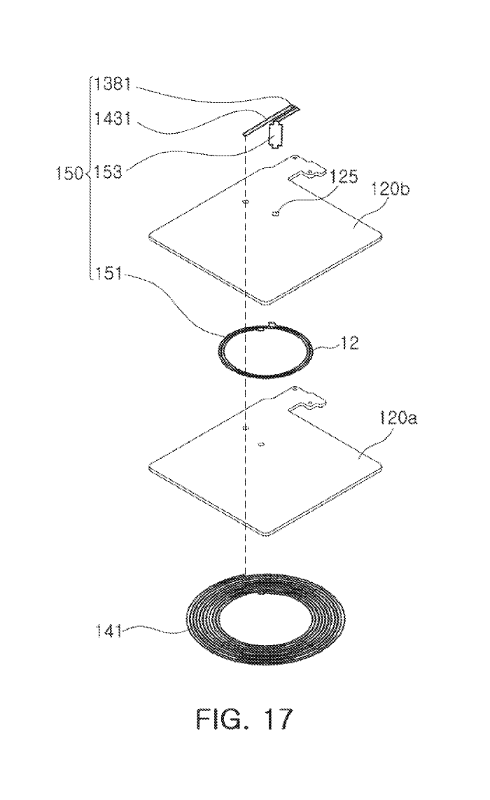

FIG. 17 is an exploded perspective view schematically illustrating an example of a coil assembly, where for convenience of explanation, the protective member 180 (FIG. 15) is omitted, but may be included in other examples. In the example, the coil assembly may be configured in a manner similar to that of the coil assembly illustrated in FIG. 9, for example. Therefore, a detailed description of such components will be omitted.

In the example of the coil assembly, the connection pad 1381 and the leading part 1431 may be included in the second wiring 150, similarly to the coil assembly illustrated in FIG. 15. Therefore, the first wiring 140 may include only the first spiral wiring 141, and the second wiring 150 may include the second spiral wiring 151, the connection wiring 153, the leading part 1431, and the connection pad 1381.

In addition, the first wiring 140 may be disposed on a first surface of the first insulating plate 120a, and the second spiral wiring 151 of the second wiring 150 may be disposed on a second surface of the first insulating plate 120a, and on a first surface of the second insulating plate 120b. In addition, the connection wiring 153, the leading part 1431, and the connection pad 1381 of the second wiring 150 may be disposed on a second surface of the second insulating plate 120b.

Therefore, in order to electrically connect the connection wiring 153 and the second spiral wiring 151 to each other, the second insulating plate 120b may include the connection conductor 125. In an example in which the protective member (180, FIG. 15) is formed, a pad hole may be formed in the protective member (180, FIG. 15) to expose the connection pad 1381.

The coil assembly according to the example may be manufactured by an operation of coupling the first wiring 140 prepared by the press processing or the photolithography method on a first surface of the first insulating plate 120a, an operation of forming the second spiral wiring 151 by printing the conductive material on a second surface of the first insulating plate 120a, an operation of stacking the second insulating plate 120b on the second spiral wiring 151 and then printing the connection conductor 125, the connection wiring 153, the leading part 1431, and the connection pad 1381 on the second insulating plate 120b, and an operation of attaching the protective member 180 to expose the connection pad 1381.

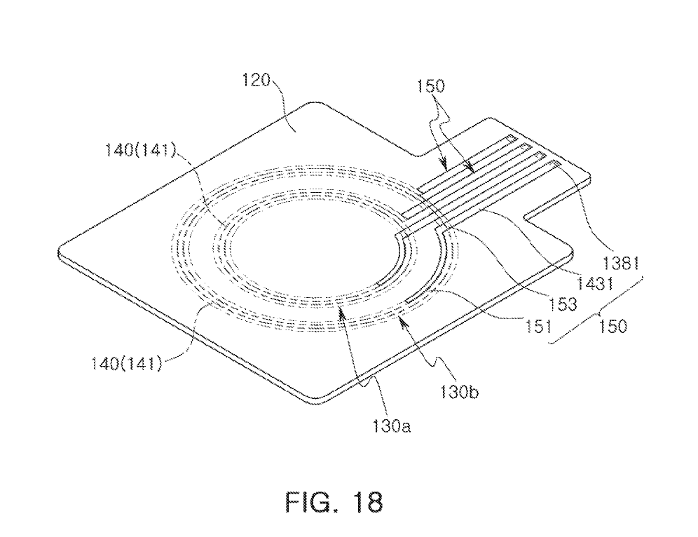

FIG. 18 is a perspective view schematically illustrating an example of a coil assembly.

The example coil assembly may include a first coil wiring 130a and a second coil wiring 130b. The first coil wiring 130a and the second coil wiring 130b may each include the first wiring 140 disposed on a first surface of the insulating plate 120, and the second wiring 150 disposed on a second surface of the insulating plate 120.

In addition, both the first wirings 140 of the first coil wiring 130a and the second coil wiring 130b may include only the first spiral wiring 141, and the second wirings 150 may include the second spiral wiring 151, the connection wiring 153, the leading part 1431, and the connection pad 1381.

In a non-limiting example, the first coil wiring 130a and the second coil wiring 130b may each perform at least one function of transmission and reception of power for wireless charging, radio frequency identification (RFID), near-field communication (NFC), and magnetic secure transmission (MST), for example.

For example, the first coil wiring 130a may be used for transmission and reception of power for wireless charging, and the second coil wiring 130b may be used for any one of the example RFID, NFC, and MST.

In addition, various deformations may be implemented in various examples. In a non-limiting example, the first coil wiring 130a may be used for NFC and the second coil wiring 130b may be used for MST.

Although the example illustrates the coil assembly including the two coil wirings 130a and 130b, at least a third coil wiring and a fourth coil wiring may also be additionally disposed in the same way, in other examples.

In the example the leading parts 1431 of the first coil wiring 130a and the second coil wiring 130b may be disposed in the same direction. However, a configuration of the example is not limited thereto. The leading parts 1431 of the first coil wiring 130a and the second coil wiring 130b may also be disposed in different directions. For example, the connection pad 1381 of the first coil wiring 130a and the connection pad 1381 of the second coil wiring 130b may be disposed in opposite directions.

In the examples described above, an example in which the coil wirings are used for transmission and reception of power for wireless charging is described as an example, but the coil wirings may also be used as an antenna, in other examples. In a non-limiting example, the coil wirings may each be used as an antenna that performs at least one function of the example radio frequency identification (RFID), near-field communication (NFC), and magnetic secure transmission (MST).

As set forth above, according to the various examples, the coil assembly may be manufactured by coupling the first wiring onto a first surface of the insulating plate and printing the conductive material on a second surface of the insulating plate and the through hole to form the second wiring and the connection conductor. Therefore, the coil assembly may be very easily manufactured, and the manufacturing costs thereof may be greatly reduced as compared to the typical coil assembly using FPCB.

Further, since the second wiring may be disposed in the insertion groove formed in the first wiring, the thickness of the coil assembly may be significantly reduced, and as a result, the coil assembly may be easily mounted in the thin type portable terminal.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A coil assembly comprising:
an insulating plate;
a first wiring disposed on a first surface of the insulating plate and comprising a first spiral wiring; and
a second wiring disposed on a second surface of the insulating plate, and electrically connected to the first wiring,
wherein the second wiring comprises a second spiral wiring that extends from the first spiral wiring, and
the first wiring and the second wiring have different cross-sectional shapes.

2. The coil assembly of claim 1, wherein the first wiring is formed so that a width of a bonded surface of the first wiring that is bonded to the insulating plate is narrower than a width of an opposite surface of the bonded surface of the first wiring, and
the second wiring is formed so that a width of a bonded surface of the second wiring that is bonded to the insulating plate is greater than or equal to a width of an opposite surface of the bonded surface of the second wiring.

3. The coil assembly of claim 1, wherein the first wiring is bonded to the insulating plate through an adhesive layer, and
the second wiring is directly bonded to the insulating plate.

4. The coil assembly of claim 1, further comprising a connection conductor disposed to penetrate through the insulating plate,
wherein the first wiring and the second wiring are electrically connected to each other through the connection conductor.

5. The coil assembly of claim 1, wherein the first wiring comprises a leading part disposed to be spaced apart from the first spiral wiring, and
the second wiring comprises a connection wiring that extends in an outer diameter direction from the second spiral wiring, and the connection wiring is connected to the leading part.

6. The coil assembly of claim 5, wherein the first wiring comprises an insertion groove formed in a position that faces the connection wiring, and
at least a portion of the connection wiring is disposed in the insertion groove.

7. The coil assembly of claim 5, wherein the connection wiring is branched into a plurality of paths.

8. The coil assembly of claim 5, wherein the connection wiring has a line width greater than the first wiring or the second spiral wiring.

9. The coil assembly of claim 5, wherein the first wiring comprises a connection part disposed to be spaced apart from the first spiral wiring,
the second wiring comprises an arc shaped wiring disposed to be spaced apart from the second spiral wiring, and
the second spiral wiring and the arc shaped wiring are electrically connected to each other through the connection part.

10. The coil assembly of claim 1, wherein the second wiring further comprises:
a connection wiring that extends in an outer diameter direction from the second spiral wiring;
connection parts that respectively extend from the first spiral wiring and the connection wiring; and
connection pads included in end portions of the connection parts.

11. The coil assembly of claim 10, further comprising a protective member disposed to cover the second wiring,
wherein the connection pads comprise a region in which the connection parts are exposed externally from the protective member through pad holes formed in the protective member.

12. The coil assembly of claim 11, further comprising a metal layer stacked on the connection parts exposed through the pad holes of the protective member.

13. The coil assembly of claim 1, wherein the second spiral wiring is formed in an arc shape.

14. The coil assembly of claim 1, wherein the second wiring is formed of a metal thin film wiring printed with a conductive material on the insulating plate.

15. The coil assembly of claim 1, further comprising:
a first coil wiring configured by the first wiring and the second wiring; and
a second coil wiring disposed to be stacked with the first coil wiring,
wherein the first coil wiring and the second coil wiring each perform any one function of transmission and reception of power for wireless charging, radio frequency identification (RFID), near filed communication (NFC), and magnetic secure transmission (MST).

16. The coil assembly of claim 15, wherein the second coil wiring is in a proximate location to the first coil wiring.

17. The coil assembly of claim 1, wherein the second wiring has a thickness equal to or less than the first wiring.

18. The coil assembly of claim 1, wherein the second spiral wiring has a line width equal to or less than the first spiral wiring.

19. A coil assembly comprising:
an insulating plate; and
a coil wiring comprising a first wiring disposed on a first surface of the insulating plate and a second wiring disposed on a second surface of the insulating plate,
wherein the first wiring comprises an insertion groove formed in a position that faces the second wiring, and
at least a portion of the second wiring is disposed in the insertion groove.

20. The coil assembly of claim 19, wherein the coil wiring comprises spiral wirings, and
the spiral wirings are disposed to be distributed in the first wiring and the second wiring.

21. The coil assembly of claim 19, wherein a spiral wiring of the second wiring has a line width narrower than a spiral wiring of the first wiring.

22. The coil assembly of claim 19, wherein a spiral wiring of the second wiring is disposed at a position that corresponds to a center region of the coil wiring that is formed by a spiral wiring of the first wiring.

23. A coil assembly method comprising:
bonding a first wiring to a first surface of an insulating plate using an adhesive substrate;
printing a conductive material on a second surface of the insulating plate to form a second wiring;
printing a connection conductor on the second surface of the insulating plate; and
electrically connecting the first wiring to the second wiring through the connection conductor to form the coil assembly.

24. The method of claim 23, further comprising attaching a first protective member to a surface of the first wiring and attaching a second protective member to a surface of the second wiring.

25. The method of claim 24, wherein the first wiring and the second wiring have different cross-sectional shapes.
